(19) United States
(12) Patent Application Publication
(10) Pub. No.: US 2008/0202998 A1
(43) Pub. Date: Aug. 28, 2008

(54) Sewage treatment system for breeding system

(76) Inventor: Kuo-Tang Tseng, Taipei City (TW)

Correspondence Address: BACON & THOMAS, PLLC, 625 SLATERS LANE, FOURTH FLOOR, ALEXANDRIA, VA, 22314, US

(21) Appl. No.: 11/709,851

(22) Filed: Feb. 23, 2007

(51) Int. Cl. A01K 63/04

(52) U.S. Cl. 210/167.21

(57) ABSTRACT

A sewage treatment system for a breeding system able to guide sewage out of the breeding system to be purified and fed back to breeding ponds for reusing, it can be applied for one breeding pond or applied simultaneously for multiple breeding ponds, and it comprises: a purifying tank, at least a dirt discharging tube to lead sewage in the breeding ponds into a purifying tank; and at least a water take-in tube for feeding purified sewage from the purifying tank back to the breeding ponds. Wherein each dirt discharging tube has a dirt collecting portion; by multiple deposition and purification treatments on the sewage in the breeding ponds with the dirt discharging tubes and the purifying tank, the quality of water in the breeding system can be elevated, and environment pollution during breeding can be effectively reduced.

### BACKGROUND OF THE INVENTION

1. Field of the Invention

The present invention relates to a sewage treatment technique, and especially to a sewage treatment technique for one or multiple breeding ponds, the technique can lead sewage out of the breeding ponds to be purified and then pour it back into the breeding ponds for reusing; this not only can maintain the quality of water in the breeding ponds, but also can lower environment pollution during the process of breeding.

2. Description of the Prior Art

Conventional breeding techniques in sewage treatment for breeding ponds directly discharge sewage into rivers and water ditches, and pour fresh breeding water led from rivers or drawn from ground water to the breeding ponds to maintain good quality of water in the breeding ponds; wherein quality of the water led from rivers is subjected to being unsteady by the problem of upstream pollution, and the water drawn from ground water may has the problem of stratum sinking by overly drawing the ground water.

In the recent years, high density breeding techniques which can elevate the economic efficiency of the art of aquaculture have gradually become a tendency of development of the art of aquaculture. In practicing, one or multiple breeding ponds are provided in a space; this can not only largely increase the amount of capture of fish, but also has the advantage of saving space.

However, breeding a large amount of aquatics in a space, the amount of contaminating substances including feed, excreta, secretions etc. must be largely increased; for the purpose of keeping the quality of water in the breeding ponds, a large amount of ground water has to be used, this may make the breeding ponds discharge sewage with high condensation of contaminating substances.

In view of this, the inventor of the present invention develops a sewage treatment system for breeding ponds, with which system, sewage in the breeding ponds are led out and purified and then pour it back into the breeding ponds for reusing; this not only can maintain good quality of water in the breeding ponds, but also can reduce environment pollution during the process of breeding; and this can not only be used for normal breeding ponds, but also be used for high density breeding techniques.

### SUMMARY OF THE INVENTION

The present invention provides a sewage treatment system for a breeding system, the primary object of it is to keep the quality of water in the breeding ponds, and to reduce environment pollution during the process of breeding. The sewage treatment system for the breeding system comprises: a purifying tank which has a lead-in zone, and has a purifying zone for purifying treatment of sewage and a gathering zone for gathering purified sewage; at least a dirt discharging tube of which a water inlet is communicated with a breeding pond, and a water outlet is communicated with the lead-in zone, each dirt discharging tube has a dirt collecting portion having on its bottom end a first deposition tank; and at least a water take-in tube of which a water take-in end is communicated with the gathering zone of the purifying tank and a water supplying end supplies water for the breeding pond, for feeding purified sewage of the gathering zone back to the breeding pond for reusing.

Therefore, sewage in the breeding pond can be led through the dirt discharging tubes into the purifying tank for purifying, then the purified sewage can be poured back through the water take-in tube to breeding pond; in this way, water in the breeding pond can be reused to save water resource. And the main contaminating dirt in the sewage can be deposited and filtered out to effectively reduce environment pollution during discharging water of the breeding pond.

In order to make users clear in observing the situation that dirt is deposited in the first deposition tank, the first deposition tank can be made of transparent material.

The abovementioned purifying zone includes a net-like foam layer neighboring to the lead-in zone, a second deposition tank and a bio-filter bed layer neighboring to the gathering zone; thereby when the sewage flows from the lead-in zone to the gathering zone, it can accept the actions of the net-like foam layer, the second deposition tank and the bio-filter bed layer to be intercepted, deposited and filtered out effectively, thereby the sewage can get the effect of purifying.

Structurally, the purifying tank can further include an outer tank and an inner tank hung in the outer tank and having a bottom communicated with the outer tank, the range from an inner edge of an opening of the outer tank to an outer edge of an opening of the inner tank is called as the lead-in zone, and the area of an inner edge of the opening of the inner tank is called as the gathering zone. Thus the purifying tank presents as an annular structure, and the breeding system can have a breeding pond used singly or can have multiple breeding ponds used in a common mode.

Besides, when the sewage treatment system is used in common for multiple breeding ponds in the breeding system, the opening of the water outlet of each of the dirt discharging tubes faces downwards and is provided under the water level of the lead-in zone to maintain the water in all the breeding ponds in a level same as that of the lead-in zone according to the principle of pressure balancing.

As compared with the conventional breeding techniques, the present invention can save water resource by purifying for reusing sewage; and can have the main contaminating dirt in the sewage deposited and filtered out to effectively reduce environment pollution during discharging water of the breeding pond.

Besides, the present invention can be applied to a high-density breeding pond to increase its effect of dirt discharging. Such a high-density breeding pond is composed of multiple breeding ponds stacking part of them on others, wherein the lower breeding ponds have larger areas than that of the upper ones, and the upper breeding ponds are surrounded by the lower ones.

By virtue that the levels of bottoms of the above stated breeding ponds are different from one another but the water levels of the breeding ponds are same, hence the higher bottoms of the breeding ponds have smaller water pressures and inferior capability of water discharging, thereby these breeding ponds have inferior capability of dirt discharging. In applying the present invention to the high-density breeding pond, the water inlets of all the dirt discharging tubes are provided respectively on the bottoms of the breeding ponds, and then all the dirt discharging tubes are bent and extended to have their water outlets located at the same level to eliminate the pressure difference of the bottoms of these breeding ponds, so that all the breeding ponds can have the same effect of dirt discharging.

The present invention will be apparent after reading the detailed description of the preferred embodiment thereof in reference to the accompanying drawings.

### BRIEF DESCRIPTION OF THE DRAWINGS

FIG. 1 is a sectional schematic view of a first embodiment of the present invention;

FIG. 2 is a schematic plan view of a second embodiment of the present invention in use;

FIG. 3 is a schematic sectional view of a third embodiment of the present invention;

FIG. 4 is a schematic top view of the third embodiment of the present invention;

FIG. 5 is a sectional schematic view of a fourth embodiment of the present invention;

FIG. 6 is a sectional schematic view of a fifth embodiment of the present invention.

### DETAILED DESCRIPTION OF THE PREFERRED EMBODIMENT

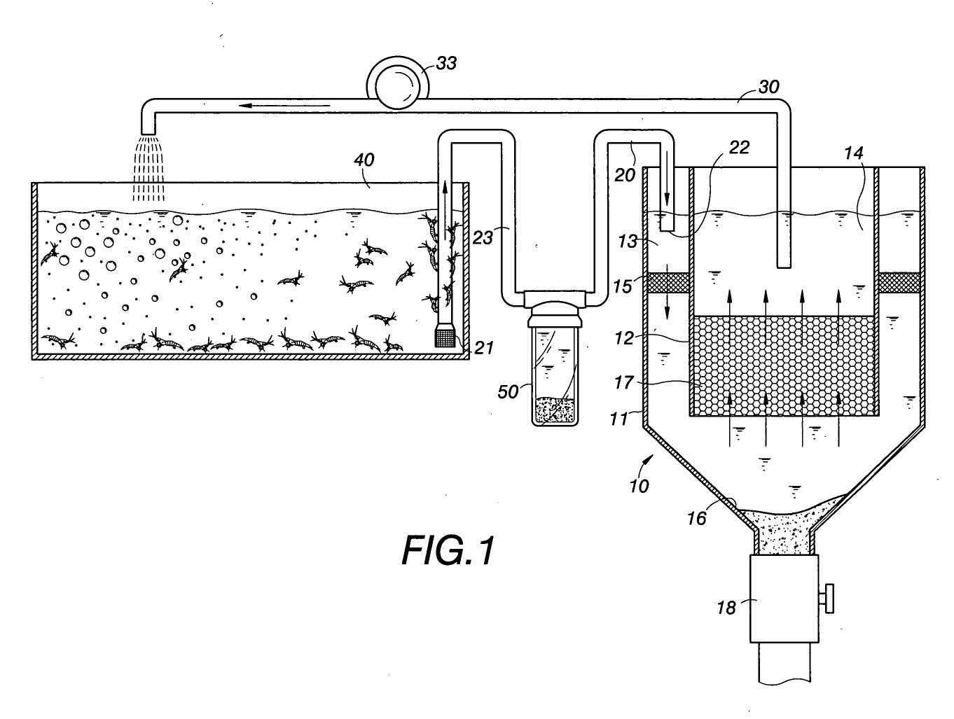

Referring firstly to FIG. 1 showing a sectional schematic view of a first embodiment of the present invention, it is shown in the drawing a sewage treatment system for a breeding system, the sewage treatment system comprises: a purifying tank 10, at least a dirt discharging tube 20 and at least a water take-in tube 30.

The purifying tank 11 has an outer tank 11, an inner tank 12 hung in the outer tank 11 and having a bottom communicated with the outer tank 11, the range from an inner edge of an opening of the outer tank 11 to an outer edge of an opening of the inner tank 12 forms a lead-in zone 13, and the area of an inner edge of the opening of the inner tank 12 forms a gathering zone 14; the lead-in zone 13 and the gathering zone 14 form a purifying zone for purifying treatment of sewage. The purifying zone includes a net-like foam layer 15 neighboring to the lead-in zone 13, a second deposition tank 16 and a bio-filter bed layer 17 neighboring to the gathering zone 14.

A water inlet 21 of the dirt discharging tube 20 is communicated with the breeding pond, and a water outlet 22 of the dirt discharging tube 20 is communicated with the lead-in zone 13, each dirt discharging tube 20 has a dirt collecting portion 23 between its water inlet 21 and its water outlet 22; in this embodiment, the dirt collecting portion 23 is located at a middle section of the dirt discharging tube 20 and bends downwards to form a “U” shape, and the bottom end of the dirt collecting portion 23 has a first deposition tank 50. In order to make users clear in observing the situation that dirt is deposited in the first deposition tank 50, the first deposition tank 50 can be made of transparent material to form a bottle shape for the convenience of detachment to clear away the deposited dirt.

A water take-in end 31 of the water take-in tube 30 is communicated with a gathering zone 14 of the purifying tank 10, and a water supplying end 32 of the water take-in tube 30 supplies water for the breeding pond 40, by operation of a motor 33, purified sewage in the gathering zone 14 can be fed back to the breeding pond 40 for reusing.

The sewage in the breeding pond 40 can be led into the purifying tank 10 by providing the dirt discharging tube 20, during this process, through the actions of the net-like foam layer 15, the second deposition tank 16 and the bio-filter bed layer 17, the sewage can get the effect of purifying through the processes of first time deposition, interception, second time deposition and filtering out etc., then the purified sewage can be poured back through the water take-in tube 30 to the breeding pond 40, in this way, water in the breeding pond 40 can be reused to save water resource. And the main contaminating dirt in the sewage has been purified by the processes of the first time deposition, the interception, the second time deposition and the filtering out etc., thereby when the sewage is discharged out of the breeding pond 40, environment pollution can be effectively reduced. And more, the bottom of the second deposition tank 16 can be provided with a second control valve 18 which can be opened in an automatic or manual controlling mode to eliminate the deposit in the second deposition tank 16. For example: when the second control valve 18 is an electromagnetic valve, opening/closing of the second control valve 18 can be controlled by an automatic control device, thereby the deposit in the second deposition tank 16 can be eliminated automatically.

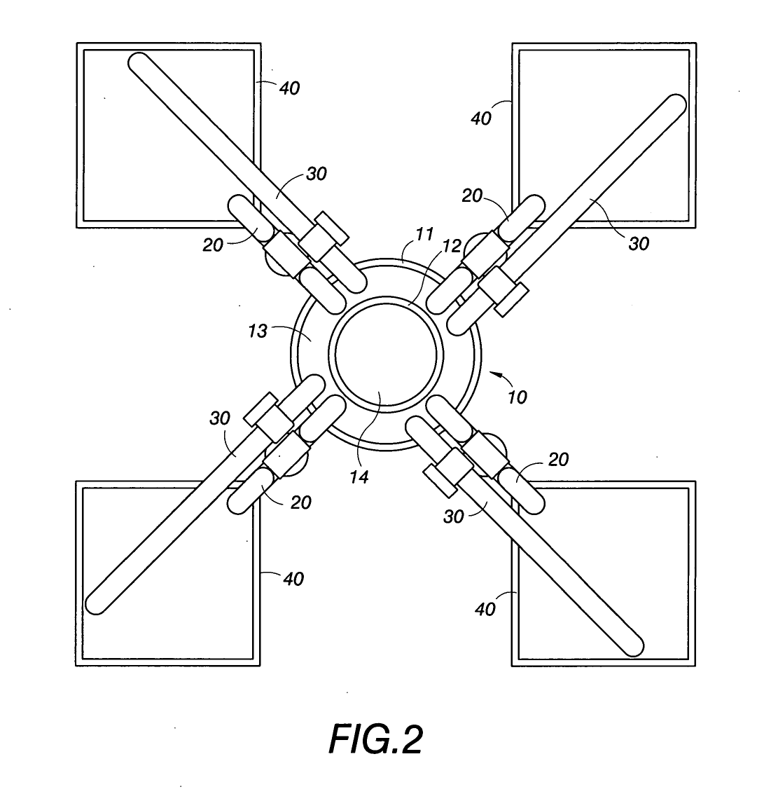

Referring to FIGS. 1 and 2, wherein FIG. 2 is a schematic plan view of a second embodiment of the present invention in use, by virtue that the purifying tank 10 is generally an annular structure, it can be applied for one breeding pond (as shown in FIG. 1), or more suitable, it can be applied simultaneously for multiple breeding ponds (as shown in FIG. 2).

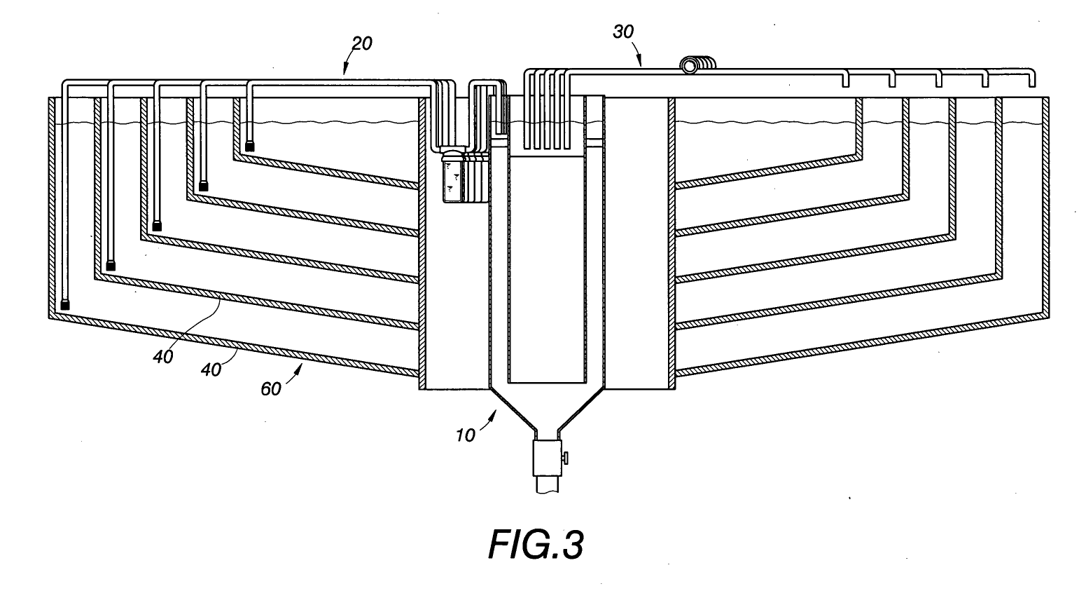

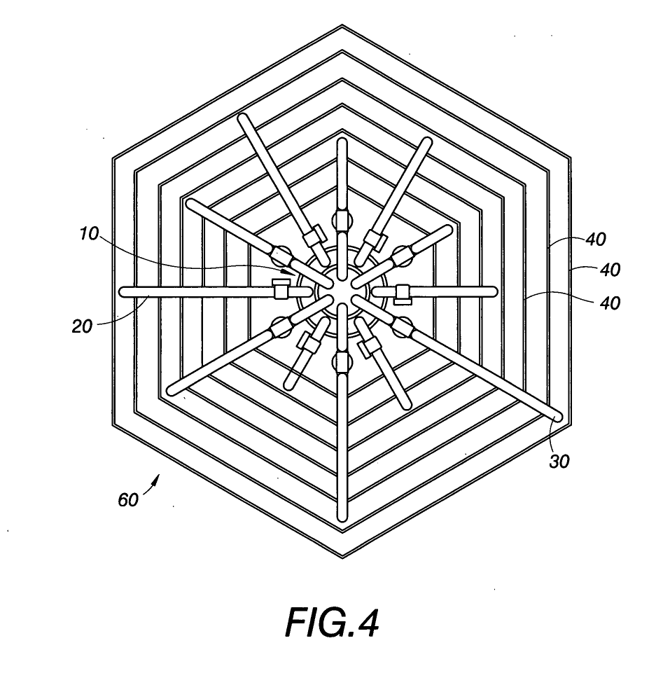

Referring to FIGS. 3 and 4 which are respectively a sectional schematic view and a schematic top view of a third embodiment of the present invention, it is depicted in these drawings that, the sewage treatment system for the breeding system of the present invention can be applied to a high density breeding pond 60 in practicing, in which multiple breeding ponds 40 can obtain better water quality; and when the sewage treatment system is used in common for the multiple breeding ponds 40, an opening of the water outlet 22 of each of the dirt discharging tubes 20 faces downwards and is provided under the water level of the lead-in zone 13 to maintain the water in all the breeding ponds 40 in a level same as that of the lead-in zone 13 according to the principle of pressure balancing; this principle of pressure balancing can also be applied to a second embodiment, and no further narration about this is required.

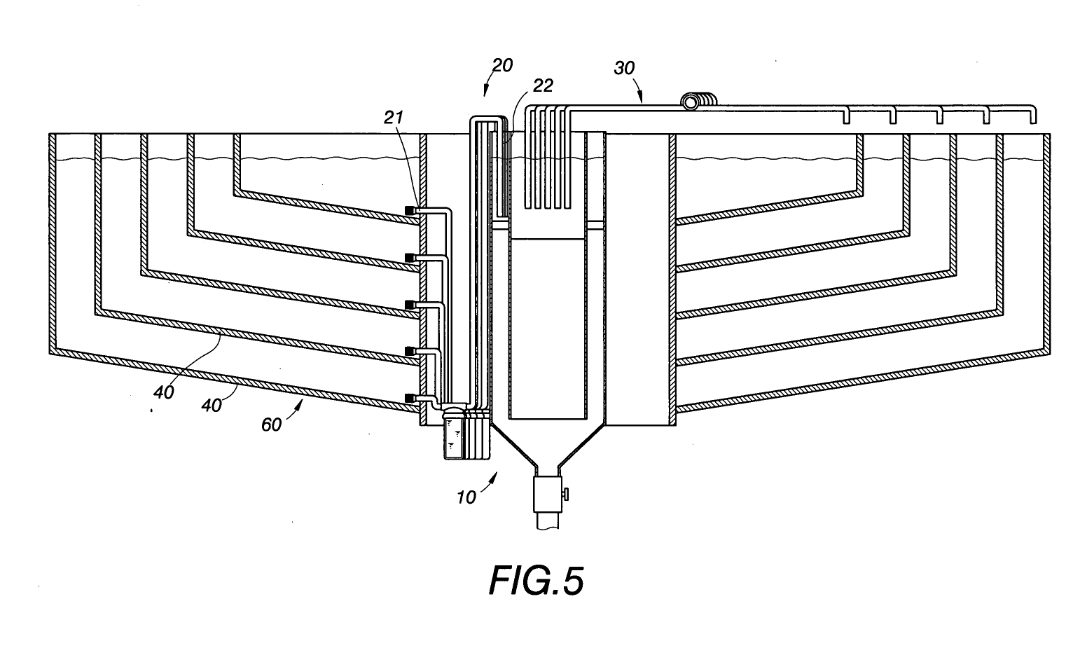

Referring to FIG. 5 which is a sectional schematic view of a fourth embodiment of the present invention, this embodiment discloses another mode of using the sewage treatment system for breeding ponds of the present invention for a high density breeding pond 60; the high density breeding pond 60 is composed of multiple breeding ponds 40 stacking part of them on others, wherein the lower breeding ponds 40 have larger areas than that of the upper ones 40, and the upper breeding ponds 40 are surrounded by the lower ones 40.

In the drawing shown, by virtue that the levels of bottoms of the above stated breeding ponds 40 are different from one another but the water levels of the breeding ponds 40 are same, hence the higher bottoms of the breeding ponds 40 have smaller water pressures and inferior capability of water discharging, thereby these breeding ponds 40 have inferior capability of dirt discharging. In applying the present invention to the high-density breeding pond 60, the water inlets 21 of all the dirt discharging tubes 20 are provided respectively on the bottoms of the breeding ponds 40, and then all the dirt discharging tubes 20 are bent and extended to have their water outlets 22 located at the same level to eliminate the pressure difference of the bottoms of these breeding ponds 40, so that all the breeding ponds 40 can have the same effect of dirt discharging.

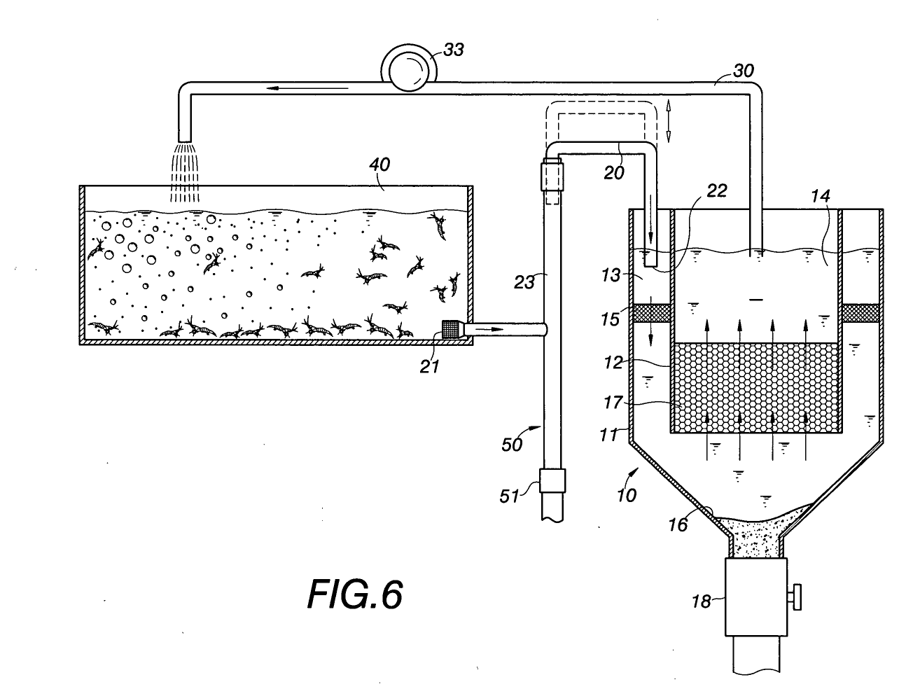

Referring to FIG. 6 which is a sectional schematic view of a fifth embodiment of the present invention, in this embodiment, the bottom of the dirt collecting portion 23 is connected with the first deposition tank 50 which is in the form of a tube, the first deposition tank 50 is provided therebelow with a first control valve 51, in order that the first control valve 51 can be opened in an automatic or manual controlling mode, to eliminate the deposit in the first deposition tank 50. For example: when the first control valve 51 is an electromagnetic valve, opening/closing of the first control valve 51 can be controlled by an automatic control device, thereby the deposit in the first deposition tank 50 can be eliminated automatically.

Secondly, the water outlets 22 of the dirt discharging tubes 20 can also be adjustable structurally in level in practicing, so that the breeding ponds 40 can have their water levels adjusted in corresponding to those of the dirt discharging tubes 20.

The embodiment stated and depicted above is only for illustrating the present invention and not for giving any limitation to the scope of the present invention, it will be apparent to those skilled in this art that various equivalent modifications or changes without departing from the spirit of this invention shall also fall within technical scope of the appended claims.

1. A sewage treatment system for a breeding system including at least a breeding pond, said sewage treatment system comprises:
a purifying tank which has a lead-in zone, and has a purifying zone for purifying treatment of sewage and a gathering zone for gathering purified sewage;
at least a dirt discharging tube, a water inlet of each of said dirt discharging tubes is communicated with one of said breeding ponds, and a water outlet of each of said dirt discharging tubes is communicated with said lead-in zone, each of said dirt discharging tubes has a dirt collecting portion between a water inlet and a water outlet thereof, said dirt collecting portion has on its bottom end a first deposition tank; and
at least a water take-in tube of which a water take-in end is communicated with said gathering zone of said purifying tank and a water supplying end supplies water for said breeding pond, for feeding purified sewage of said gathering zone back to said breeding pond for reusing.

2. The sewage treatment system for a breeding system as in claim 1, wherein said dirt collecting portion bends downwards to form a “U” shape.

3. The sewage treatment system for a breeding system as in claim 1, wherein said dirt collecting portion extends downwards, a bottom of said dirt collecting portion is connected with said first deposition tank which is in a form of a tube.

4. The sewage treatment system for a breeding system as in claim 1, wherein said first deposition tank is made of transparent material and forms a bottle shape.

5. The sewage treatment system for a breeding system as in claim 3, wherein said first deposition tank is provided therebelow with a first control valve.

6. The sewage treatment system for a breeding system as in claim 1, wherein said purifying zone includes a net-like foam layer neighboring to said lead-in zone, and includes a second deposition tank and a bio-filter bed layer neighboring to said gathering zone.

7. The sewage treatment system for a breeding system as in claim 6, wherein a bottom of said second deposition tank is provided with a second control valve to eliminate deposit.

8. The sewage treatment system for a breeding system as in claim 1, wherein said purifying tank further includes an outer tank and an inner tank hung in said outer tank and having a bottom communicated with said outer tank, a range from an inner edge of an opening of said outer tank to an outer edge of an opening of said inner tank is said lead-in zone, and an area of an inner edge of said opening of said inner tank is said gathering zone.

9. The sewage treatment system for a breeding system as in claim 1, said sewage treatment system is provided for common use of multiple breeding ponds, wherein an opening of each of said water outlets of said at least a dirt discharging tube faces downwards and is provided under a water level of said lead-in zone to maintain water in all said breeding ponds in a level same as that of said lead-in zone according to a principle of pressure balancing.

10. The sewage treatment system for a breeding system as in claim 1, wherein said at least a dirt discharging tube is plural by number, said water inlets of all said dirt discharging tubes are provided respectively on bottoms of said breeding ponds stacking part of them on others, said dirt discharging tubes have said water outlets located at a same level to eliminate pressure difference of bottoms of said breeding ponds, so that all said breeding ponds can have same effect of dirt discharging.

11. The sewage treatment system for a breeding system as in claim 1, wherein said water outlets of said dirt discharging tubes also are adapted to adjusting in level.
